(19) United States
(12) Patent Application Publication
(10) Pub. No.: US 2004/0162857 A1
(43) Pub. Date: Aug. 19, 2004

(54) System for managing and dynamically recreating factory environments

(76) Inventor: David A. Butts, Austin, TX (US)

Correspondence Address: HAMILTON & TERRILE, LLP, P.O. BOX 203518, AUSTIN, TX, 78720, US

(21) Appl. No.: 10/367,091

(22) Filed: Feb. 14, 2003

(51) Int. Cl. G06F 12/00

(52) U.S. Cl. 707/203

(57) ABSTRACT

A method for managing a factory build environment. The method includes storing a plurality of files, versioning each of the plurality of files, grouping the plurality of files into a file set, versioning the file set, grouping a plurality of file sets into a factory build environment, and versioning the factory build environment.

### BACKGROUND OF THE INVENTION

1. Field of the Invention

The present invention relates to the field of versioning software, and more particularly to versioning software in a factory build environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

It is known to install software and to perform tests on information handling systems before they are shipped to businesses or individual customers. A goal of software installation is to efficiently produce a useful, reliable information handling system. Software installation often includes loading a desired package of software onto the information handling system, preparing appropriate environment variables for the computer, and preparing appropriate environment variables for the computer, and preparing appropriate initialization files for the loaded software.

In known software installation systems, several different types of executable files all residing in a flat directory structure are updated nightly with new content. A snap-shot, at any point in time, of this flat directory structure is called a factory build environment. Because the content of this structure is frequently changing, the factory build environment is not constant and a previous factory build environment is often lost when updates are made to the factory build environment.

Updates have the potential to introduce problems into the software installation system and thus break the factory build environment. Additionally, rebuilding client machines that were originally built with an earlier factory build environment is often necessary. There is no accurate way to return to a previous factory build environment. Also, the update of the factory build environment is limited to a very small window during the early morning factory shift change because the factory files are otherwise locked or in use while systems are being built.

### SUMMARY OF THE INVENTION

In accordance with the present invention, a three tier versioning methodology along with dynamic directory/file aliasing is set forth. First, the files themselves are versioned and stored normally using any versioning/storage technique available. Next, unique versions of different files are grouped into an entity called a file set which, itself, is versioned. A file set is generic and may represent any sort of installable or executable piece of the factory environment. Next, unique versions of file sets are grouped into an entity called a factory build environment which is also versioned. At any point in time, the versioned files that comprise a given versioned factory build environment can be dynamically aliased into a single consumable entity called a FAST Drive.

In one embodiment, the invention relates to a method for managing a factory build environment. The method includes storing a plurality of files, versioning each of the plurality of files, grouping the plurality of files into a file set, versioning the file set, grouping a plurality of file sets into a factory build environment, and versioning the factory build environment.

In another embodiment, the invention relates to an apparatus for managing a factory build environment. The apparatus includes means for storing a plurality of files, means for versioning each of the plurality of files, means for grouping the plurality of files into a file set, means for versioning the file set, means for grouping a plurality of file sets into a factory build environment, and means for versioning the factory build environment.

In another embodiment, the invention relates to a factory build environment management system. The factory build environment management system includes a plurality of files, a plurality of file sets and a factory build environment. Each of the plurality of files is versioned and the file sets are uniquely versioned. Each of the plurality of file sets include unique versions of at least one of the plurality of files. The factory build environment is uniquely versioned and includes a uniquely versioned group of file sets.

In another embodiment, the invention relates to an information handling system. The information handling system includes a processor and a memory coupled to the processor. The memory stores a factory build environment management system. The factory build environment management system includes a plurality of files, a plurality of file sets and a factory build environment. Each of the plurality of files is versioned. Each of the plurality of file sets are uniquely versioned and include unique versions of at least some of the plurality of files. The factory build environment is uniquely versioned and includes a uniquely versioned group of file sets.

In another embodiment, the invention relates to an information handling system. The information handling system includes a processor and a memory coupled to the processor. The memory stores information regarding a factory build environment used to build the information handling system

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a block diagram of a factory build environment versioning methodology.

FIG. 3 shows a system block diagram of an information handling system.

### DETAILED DESCRIPTION

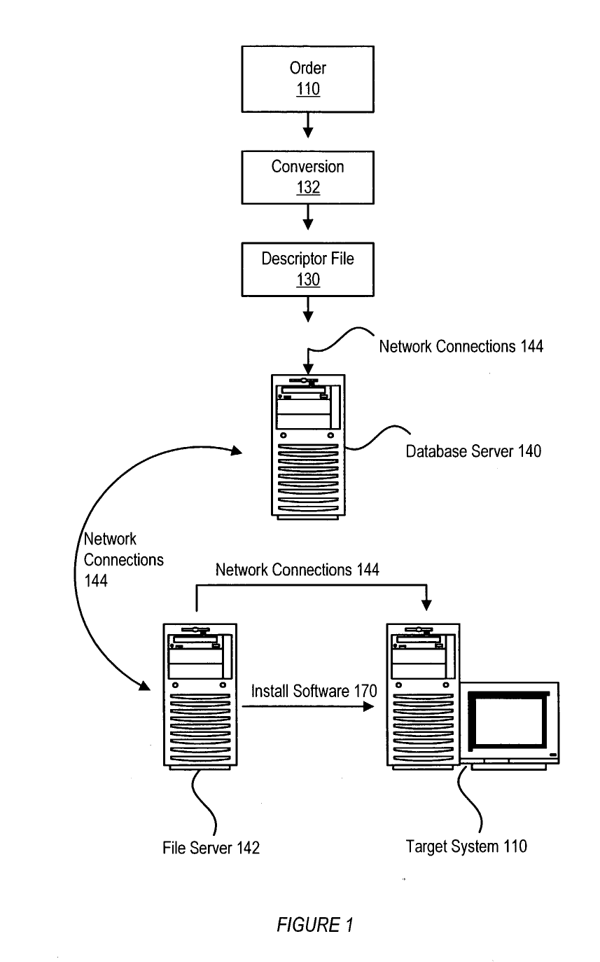

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 110.

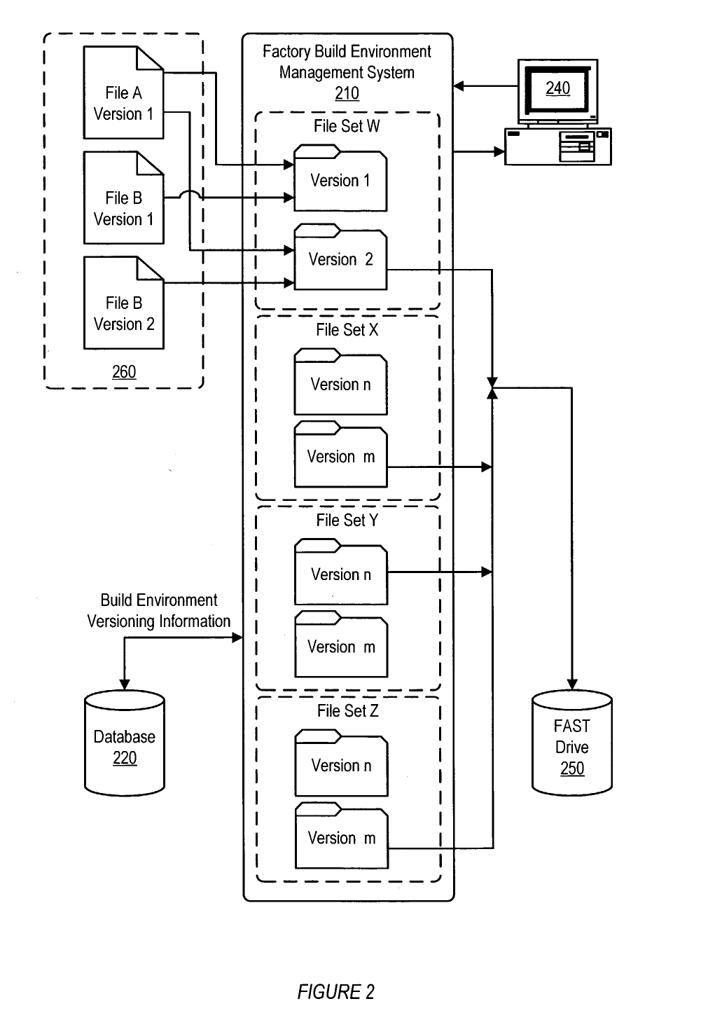

Referring to FIG. 2, a methodology 200 for maintaining versioning of the factory build environment is shown. The methodology includes a factory build environment management system 210 which is coupled to a database 220, a software file update mechanism 260 as well as a remote application system 240. Additonally the methodology includes a FAST Drive 250 which is a dynamically allocated, remotely consumable resource. Accordingly, the methodology 200 provides a three tier versioning methodology along with dynamic directory/file aliasing.

The factory build environment management system 210 includes a plurality of file sets (e.g., file set W, file set X, file set Y, and file set Z). Each file set includes a plurality of versions of files (e.g., Version 1 and Version 2 of file W and Version n and Version M of Files X, Y and Z).

In operation, the files (e.g., flat data, documents, executables, compressed images, scripts, etc.) are versioned and stored using any known versioning/storage technique available. Next, unique versions of different files (e.g., document version one (1), executable version two (2), and script version one (1), etc.) are grouped into a respective entity referred to as a file set (e.g., a manufacturers part number such as “PN12345,” etc.). Each file set is uniquely versioned (e.g., “PN12345” version one (1), etc.). A file set is generic and may represent any sort of installable or executable piece of the factory environment (e.g., driver, application, flat data, etc.). Next, unique versions of file sets are grouped into a respective entity referred to as a factory build environment (e.g., “Austin-Line1” version one (1), etc.). The modification of any file (e.g., script version one (1) is edited, etc.) generates a new file version (e.g., script version two (2), etc.) which, in turn, triggers a new file set version (e.g., “PN12345” version two (2), etc.) which again triggers a new factory build environment version (e.g., “Austin-Line1” version two (2), etc.). On demand, any version of the factory build environment may then be dynamically recreated by symbolically linking the unique set of versioned files contained in the versioned file sets that comprise the requested factory build environment.

In one example, a single factory build environment may include file set versions for all currently active manufacturer part numbers (e.g., drivers, applications, operating systems, etc.), all current global scripts (also referred to as an internal factory executable), and any other extraneous software artifacts (e.g., data filed, diagnostic executables, etc.) that are useful to successfully build an information handling system in the manufacturer's factory.

When an update is made to the factory software, a new instance of the factory build environment is stored. Because updates to the factory software are uniquely versioned within the factory build enviromnent management system 210, these updates can be made at any time, not only during a designated period of factory down time.

Also, by using dynamicly aliasing (e.g., using Linux symbolic links or other technology such as Microsoft Distributed File System (DFS)), the versioned files and file sets may be aliased into a single temporary directory which is called a FAST Drive 250. This aliasing allows the factory build environment management system 210 to recreate, on demand, any saved instance of a factory build environment Any remote application 240 may request a versioned factory build environment from the factory build environment management system 210. The factory build environment management system 210 dynamically creates a FAST Drive 250 to represent the versioned factory build environment. A remotely accessible path to the FAST Drive is returned to the remote application 240 to use as a consumable resource. The aliasing is temporary and can be deleted at any time after the remote application 240 no longer needs the specified version of the factory build environment (effectively deleting the FAST Drive from the factory build environment management system 210). When building an information handling system, a reference to the version of the factory build environment originally used to build the system is stored (either within the information handling system or within the factory or in both the information handling system and within the factory). Thus, the factory build environment used to build a specific information handling system may later be dynamically recreated for building a subsequent or for repairing damaged information handling systems requiring a particular factory build environment software configuration.

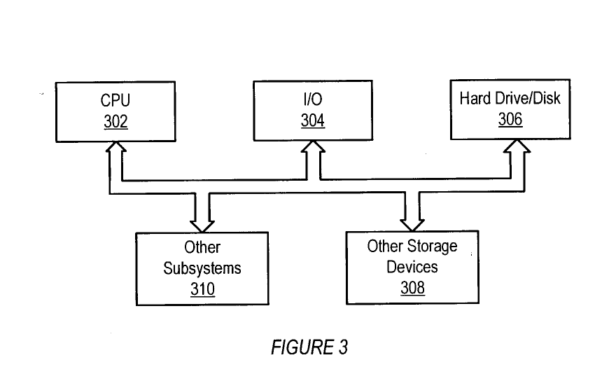

Referring briefly to FIG. 3, a system block diagram of an information handling system 300 which has software installed according to the versioning methodology is shown. The information handling system includes a processor 302, input/output (I/O) devices 304, such as a display, a keyboard, a mouse, and associated controllers, a hard disk drive 306, and other storage devices 308, such as a floppy disk and drive and other memory devices, and various other subsystems 310, all interconnected via one or more buses 312. The software that is installed according to the versioning methodology is installed onto hard disk drive 306. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

### Other Embodiments

Other embodiments are within the following claims.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for managing a factory build environment comprising:
storing a plurality of files;
versioning each of the plurality of files;
grouping the plurality of files into a file set;
versioning the file set;
grouping a plurality of file sets into a factory build environment; and
versioning the factory build environment.

2. The method of claim 1 further comprising:
a plurality of factory build environments.

3. The method of claim 1 further comprising:
regenerating a versioned factory environment by at least one of dynamically linking and aliasing a plurality of versioned files.

4. The method of claim 1 wherein:
the plurality of files include at least one of a script, a driver, an application, an operating system and a data file.

5. The method of claim 1 wherein:
the file set includes a version of the plurality of files for at least one of an active manufacturer part number, an internal factory executable and a flat data file.

6. The method of claim 1 wherein:
the factory build environment includes file sets corresponding to a respective plurality of at least one of active manufacturer part numbers, internal factory executables and flat data files.

7. An apparatus for managing a factory build environment comprising:
means for storing a plurality of files;
means for versioning each of the plurality of files;
means for grouping the plurality of files into a file set;
means for versioning the file set;
means for grouping a plurality of file sets into a factory build environment; and
means for versioning the factory build environment.

8. The apparatus of claim 7 further comprising:
means for grouping a plurality of file sets into a plurality of factory build environments; and
means for versioning the plurality of factory build environments.

9. The apparatus of claim 7 further comprising:
means for regenerating a versioned factory environment by at least one of dynamically linking and aliasing a plurality of versioned files.

10. The apparatus of claim 7 wherein:
the plurality of files include at least one of a script, a driver, an application, an operating system and a data file.

11. The apparatus of claim 7 wherein:
the file set includes a version of the plurality of files for at least one of an active manufacturer part number, an internal factory executable and a flat data file.

12. The apparatus of claim 7 wherein:
the factory build environment includes file sets corresponding to a respective plurality of at least one of active manufacturer part numbers, internal factory executables and flat data files.

13. A factory build environment management system comprising:
a plurality of files, each of the plurality of files being versioned;
a plurality of file sets, each of the plurality of file sets including unique versions of at least some of the plurality of files, each of the plurality of files sets being uniquely versioned; and
a factory build environment, the factory build environment including a uniquely versioned group of file sets, the factory build environment being uniquely versioned.

14. The system of claim 13 further comprising:
a plurality of factory build environments, the plurality of factory build environments each including a uniquely versioned group of file sets, each of the factory build environments being uniquely versioned.

15. The system of claim 13 further comprising:
a regenerating module, the regenerating module regenerating a versioned factory environment by at least one of dynamically linking and aliasing a plurality of versioned files.

16. The system of claim 13 wherein:
the plurality of files include at least one of a script, a driver, an application, an operating system and a data file.

17. The system of claim 13 wherein:
the file set includes a version of the plurality of files for at least one of an active manufacturer part number, an internal factory executable and a flat data file.

18. The system of claim 13 wherein:
the factory build environment includes file sets corresponding to a respective plurality of at least one of active manufacturer part numbers, internal factory executables and flat data files.

19. An information handling system comprising:
a processor;
a memory coupled to the processor, the memory storing a factory build environment management system, the factory build environment management system including
a plurality of files, each of the plurality of files being versioned;
a plurality of file sets, each of the plurality of file sets including unique versions of at least some of the plurality of files, each of the plurality of files sets being uniquely versioned; and
a factory build environment, the factory build environment including a uniquely versioned group of file sets, the factory build environment being uniquely versioned.

20. An information handling system comprising:
a processor;
a memory coupled to the processor, the memory storing information regarding a factory build environment used to build the information handling system.

21. The system of claim 20 wherein the factory build environment includes
a plurality of files, each of the plurality of files being versioned;
a plurality of file sets, each of the plurality of file sets including unique versions of at least some of the plurality of files, each of the plurality of files sets being uniquely versioned; and wherein,
the factory build environment includes a uniquely versioned group of file sets, the factory build environment being uniquely versioned.
